(19) United States
(12) Patent Application Publication
(10) Pub. No.: US 2009/0030676 A1
(43) Pub. Date: Jan. 29, 2009

(54) METHOD OF DERIVING A COMPRESSED ACOUSTIC MODEL FOR SPEECH RECOGNITION

(75) Inventors: Jun XU, Singapore (SG); Huayun ZHANG, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 11/829,031

(22) Filed: Jul. 26, 2007

(51) Int. Cl. G10L 19/02

(52) U.S. Cl. 704/203; 704/E19.001

(57) ABSTRACT

A method of deriving a compressed acoustic model for speech recognition is disclosed herein. In a described embodiment, the method comprises transforming an acoustic model into an eigenspace at step 20, determining eigenvectors of the eigenspace and their eigenvalues, and selectively encoding dimensions of the eigenvectors based on values of the eigenspace at step 30 to obtain a compressed acoustic model at steps 40 and 50.

### BACKGROUND AND FIELD OF THE INVENTION

This invention relates to a method of deriving a compressed acoustic model for speech recognition.

Speech recognition, or more commonly called automatic speech recognition has many applications such as automatic voice response, voice dialing and data entry etc. The performance of a speech recognition system is usually based on accuracy and processing speed and a challenge is to design speech recognition systems with lower processing power and smaller memory size without affecting accuracy or processing speed. In recent years, this challenge is greater with smaller and more compact devices also demanding some form of speech recognition application.

In the paper “Subspace Distribution Clustering Hidden Markov Model” by Enrico Bocchieri and Brian Kan-Wing Mak, IEEE transactions on Speech and Audio Processing, Vol. 9, No. 3, March 2001, a method was proposed which reduces the parameter space of acoustic models, thus resulting in savings in memory and computation. However, the proposed method still requires a relative large amount of memory.

It is an object of the present invention to provide a method of deriving a compressed acoustic model for speech recognition which provides the public with a useful choice and/or alleviates at least one of the disadvantages of the prior art.

### SUMMARY OF THE INVENTION

This invention provides a method of deriving a compressed acoustic model for speech recognition. The method comprises: (i) transforming an acoustic model into eigenspace to obtain eigenvectors of the acoustic model and their eigenvalues, (ii) determining predominant characteristics based on the eigenvalues of every dimension of each eigenvector; and (iii) selectively encoding the dimensions based on the predominant characteristics to obtain the compressed acoustic model.

Through the use of eigenvalues, this provides means for determining the importance of each dimension of the acoustic model which forms the basis for the selective encoding. In this way, this creates a compressed acoustic model having a much reduced size, than in cepstral space.

Scalar quantization is preferred for the encoding since such quantizing is “lossless”.

Preferably, determining the predominant characteristics includes identifying eigenvalues that are above a threshold. The dimensions corresponding to eigenvalues above the threshold may be coded with a higher quantization size than dimensions with eigenvalues below the threshold.

Advantageously, prior to the selectively encoding, the method includes normalising the transformed acoustic model to convert every dimension into a standard distribution. The selectively encoding may then include coding each normalised dimension based on a uniform quantization code book. Preferably, the code book has a one byte size, although this is not absolutely necessary and depends on the application.

If one byte code book is used, then preferably, the normalised dimensions having an importance characteristic higher than an importance threshold is coded using one byte code word. On the other hand, the normalised dimensions having an importance characterise lower than an importance threshold may then be coded using a code word of less than 1 byte.

The invention further provides an apparatus/system for deriving a compressed acoustic model for speech recognition. The apparatus comprises means for transforming an acoustic model into eigenspace to obtain eigenvectors of the acoustic model and their eigenvalues, means for determining predominant characteristics based on the eigenvalues of every dimension of each eigenvector; and means for selectively encoding the dimensions based on the predominant characteristics to obtain the compressed acoustic model.

### BRIEF DESCRIPTION OF THE DRAWINGS

An embodiment of the invention will now be described, by way of example, with reference to the accompanying drawings in which,

FIG. 1 is a block diagram showing a broad overview of a process for deriving a compressed acoustic model in eigenspace for speech recognition;

FIG. 2 is a block diagram showing the process of FIG. 1 in greater detail and also including decoding and decompression steps;

FIG. 3 is a graphical representation of linear transformation of an uncompressed acoustic model;

FIG. 4 including FIGS. 4a to 4c are graphs showing standard normal distribution of dimensions of eigenvectors after normalisation;

FIG. 5 illustrates the different coding techniques with and without discriminant analysis; and

FIG. 6 is a table showing different model compression efficiencies.

### DETAILED DESCRIPTION OF THE PREFERRED EMBODIMENT

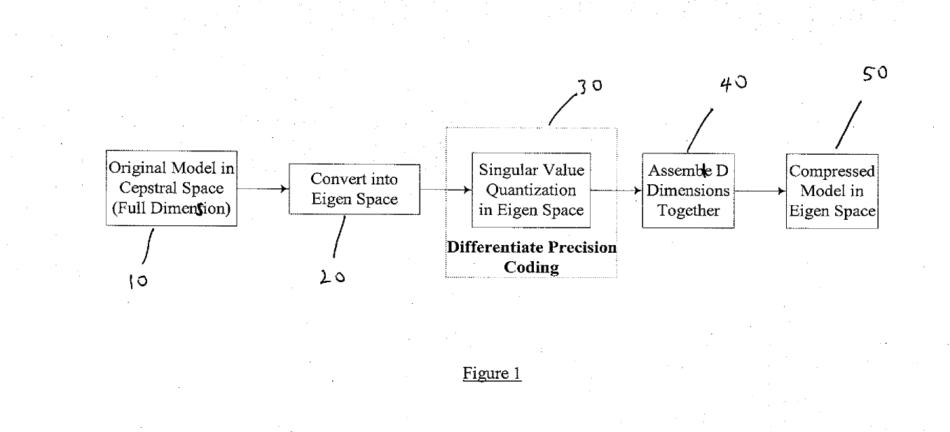

FIG. 1 is a block diagram showing a broad overview of a preferred process for deriving a compressed acoustic model of this invention. At step 10, an original uncompressed acoustic model is first translated and represented in cepstral space and at step 20, the cepstral acoustic model is converted into eigenspace to determine what parameters of the cepstral acoustic model are important/useful. At step 30, parameters of the acoustic model are coded based on the importance/usefulness characteristics and thereafter, the coded acoustic features are assembled together as a compressed model in eigenspace at steps 40 and 50.

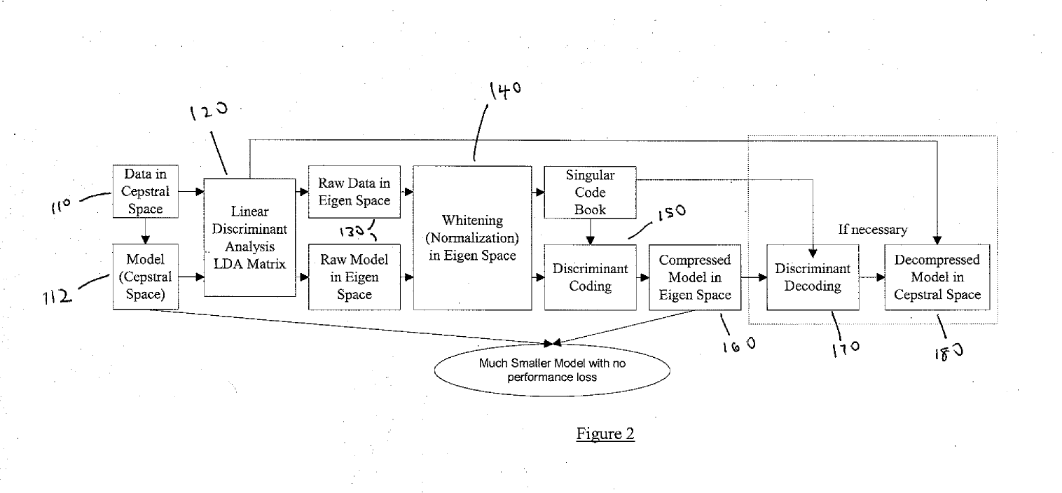

Each of the above steps will now be described in greater detail by referring to FIG. 2.

At step 110, the uncompressed original signal model such as, for example, speech input is represented in cepstral space. A sampling of the uncompressed original signal model is taken to form a model in cepstral space 112. The model in cepstral space 112 forms a reference for subsequent data input. The cepstral acoustic model data is then subjected to discriminant analysis at step 120. A Linear Discriminant Analysis (LDA) matrix is employed to the uncompressed original signal model (and sampling) to transform the uncompressed original signal model (and sampling) in cepstral space into data in eigenspace. It should be noted that the uncompressed original signal model is a vector quantity, and thus includes a quantity and a direction.

A. Discriminant Analysis

Through linear discriminant analysis, the most predominant information in the sense of acoustic classification is explored, evaluated and filtered. This is based on the realisation that in speech recognition, it is important that the speech received is processed accurately, but it may not be necessary to code all features of the speech since some may not be necessary and would not contribute to the accuracy of the recognition.

Let's assume Rⁿ is the original feature space, which is a n-dimension hyperspace. Each x ε Rⁿ has a class label that is meaningful in ASR systems. Next, at step 130, an aim is to find a linear transformation (LDA matrix) A, by converting into eigenspace, that optimize the classification performance in the transformed space y ε R^{p}, which is a p-dimension hyperspace (normally, p≦n), where

y=Ax

with y being a vector in eigenspace and x being data in cepstral space.

In LDA (Linear Discriminant Analysis) theory, A can be found from

Σ_{WC}⁻¹Σ_{BC}Φ=ΦΛ

where Σ_{WC} and Σ_{BC} are the within class (WC) and across class (BC) covariance matrix respectively, and Φ and Λ are n·n matrix of eigenvectors and eigenvalues of M_{WC}⁻¹M_{BC}, respectively.

A is constructed by choosing p eigenvectors corresponding to p largest eigenvalues. When A is derived correctly from y and x, an LDA matrix that optimises acoustic classification is derived which aids in exploring, evaluating and filtering the uncompressed original signal model.

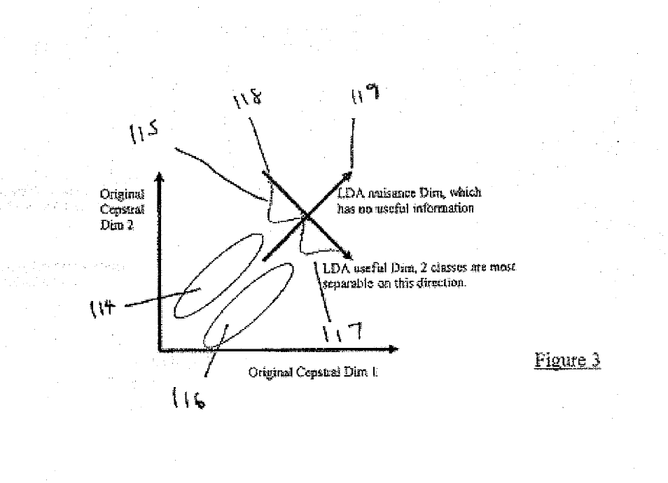

FIG. 3 shows graphically the end result of the linear transformation to reveal two classes of data along a useful dimension (Dim) and one nuisance dimension (Dim) which has no useful information. The classes of data may be, for example, phoneme, biphoneme, triphoneme and so forth. A first ellipse 114 and a second ellipse 116 both represent regions of data resulting from Gaussian distributions. A first bell curve 115 results from a projection of points from within the first ellipse 114 onto a first sub-axis 118. Similarly, a second bell curve 117 results from a projection of points from within the second ellipse 116 onto the first sub-axis 118. The first sub-axis 118 is derived using LDA on the regions of data shown in the first ellipse 114 and the second ellipse 116. A second sub-axis 119 which is orthogonal to the first sub-axis 118 is inserted at the point of intersection between the first ellipse 114 and the second ellipse 116. The second sub-axis 119 clearly separates data points into separate classes as the first ellipse 114 and the second ellipse 116 are merely approximate regions of separate classes. Thus, the classes present in the uncompressed original signal model are ascertained from the relative positions of the separated data regions. This technique may be employed primarily for the separation of two classes of data. Each class of data may also be known as a feature of the acoustic signal.

As it would be appreciated, from the data distribution of the two classes, and through LDA, it is possible to determine the eigenvalues of corresponding eigenvectors defined in order of dominance or importance based on the eigenvalues. In other words, with LDA, higher eigenvalues represents more discriminative information whereas lower eigenvalues represent lesser discriminative information.

After each feature of the acoustic signal is classified based on their predominant characteristics in the speech recognition, the acoustic data is normalised at 140.

B. Normalisation in Eigenspace

Mean estimation in eigen-space:

$$µ = E ( {y}_{t} ) = \frac{1}{T} {\sum }_{t = 1}^{T} {y}_{t}$$

Standard Variance estimation in eigen-space:

$$Σ = E ( ( {y}_{t} - E ( {y}_{t} ) ) {( {y}_{t} - E ( {y}_{t} ) )}^{T} ) = E ( {y}_{t} {y}_{t}^{T} ) - E ( {y}_{t} ) {E ( {y}_{t} )}^{T}$$

$${Σ}_{diag} = \frac{1}{T} {\sum }_{t = 1}^{T} {y}_{t}^{T} {y}_{t} - {µ}^{T} µ$$

Normalization:

ŷₜ=sqrt(Σ_{diag})·(yₜ−μ)

where yₜ=eigenspace vector, E(yₜ)=expectation of yₜ, Σ_{diag}=covariance matrix of elements on diagonal of variance, and T=time.

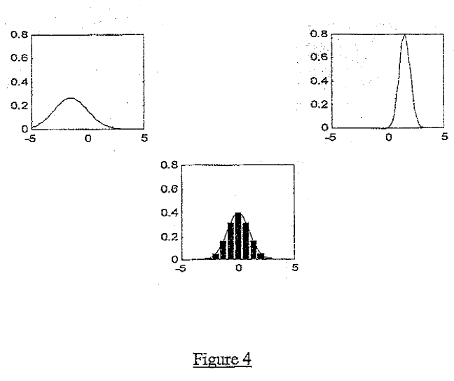

Speech feature is assumed as Gaussian distributions, this normalization converts every dimension into a standard normal distribution N(μ,σ)with μ=0 and σ=1 (see FIGS. 4a to 4c).

This normalization provides two advantages for the model compression:

Firstly, since all the dimensions share the same statistics, a uniform singular codebook can be employed for model coding-decoding at every dimension. There is no need to design different codebooks for different dimensions or use other kinds of vector codebooks. This could save memory space for model storing. If the size of the codebook is defined as 2⁸=256, one byte is enough to represent a code word.

Secondly, since the dynamic range of a codebook is limited compared to floating point representation, model coding-decoding may bring serious problems when floating point data falls outside the range of the codebook, such as overflow, truncation and saturation, which will eventually result in ASR performance degradation. With this normalization, this conversion loss can be effectively controlled. For example, if the fix-point range is set as ±3σ confidence interval, the data percentage that causes saturation problem in coding-decoding would be:

$${\int }_{- ∞}^{μ - 3 σ} {N}_{{y}_{i}} ( μ , σ ) d {y}_{i} + {\int }_{μ - 3 σ}^{+ ∞} {N}_{{y}_{i}} ( μ , σ ) d {y}_{i} \approx 0.26 \%$$

It has been found that this minor coding-decoding error/loss is unobservable in ASR performance.

C. Different Coding-Decoding Precision Based on Discriminant Capability.

After the model is normalised, it is subjected to discriminant or selective coding at 150 of the mean vectors and covariance matrices of the acoustic model based on the quantization code book size of 1 byte. The LDA projection on the eigenvector corresponding to larger eigenvalues is considered to be more important to classification. The larger the eigenvalue, the higher importance of its corresponding direction in the sense of ASR. Thus, the maximum code word size is used to represent the class.

A threshold to segregate the “larger eigenvalues” and the other eigenvalues is determined through cross validation experiments. Firstly, a part of training data and training model is set aside. The ASR performance is then evaluated based on the set-aside data. This process of training and evaluating the ASR performance is repeated for different thresholds until a threshold value is found that provides the best recognition performance.

Since dimensions in eigenspace have different importance characteristics for voice classification, different compression strategies with different precisions are employed without affecting ASR performance. Also, since all the parameters of the acoustic model are multidimensional vectors or matrices, scalar coding is implemented on every dimension of each model parameter. This is particularly advantageous since scalar coding is “lossless”. In this instance, scalar coding is “lossless” compared with ubiquitous vector quantization (VQ). VQ is a lossy compression method. The size of VQ codebook has to be increased in order to reduce quantization error. However, a larger codebook results in larger compressed model size and slower decoding process. Furthermore, it's difficult to “train” a large VQ codebook robustly with limited training data. This difficulty would reduce the accuracy for speech recognition. It should be noted that the size of a scalar codebook is significantly less. This correspondingly helps to improve decoding speed. A small scalar code book may also be estimated more robustly than a large VQ code book with limited training data. Using the small scalar code book may also help avoid additional accuracy loss introduced by quantization error. Thus, scalar quantization outperforms VQ in relation to speech recognition with limited training data.

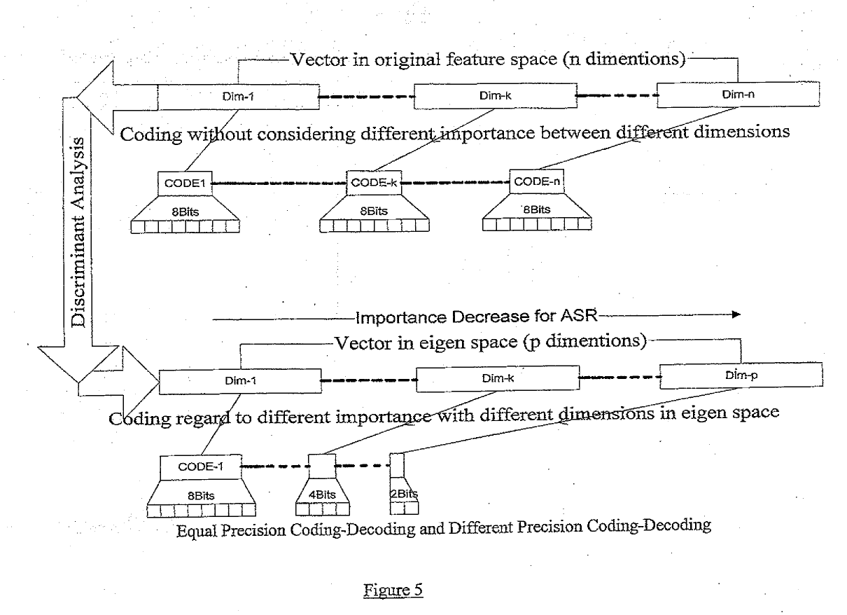

The selective coding is illustrated in FIG. 5 in which dimensions having higher eigenvalues are coded using the maximum 8 bits (1 byte) whereas dimensions having lower eigenvalues are coded using lower bits. Through this selective coding, it would be appreciated that a reduction in memory size can be achieved.

After the selective coding, a compressed model in eigenspace is derived at 160. The compressed model in eigenspace is significantly smaller than data in cepstral space.

FIG. 2 also illustrates decoding steps 170 and 180 where, if necessary, the compressed model are decoded in a discriminant manner and the compressed model decompressed to obtain the original uncompressed model.

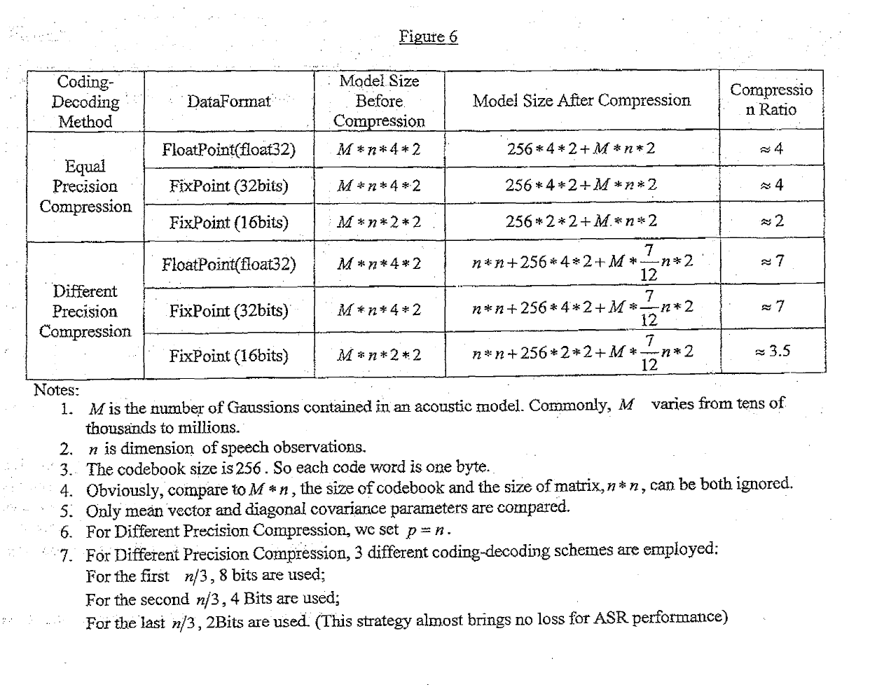

An example of the of the compression efficiency is shown in FIG. 6 which is a table depicting compression ratios of equal compression techniques compared with selective compression techniques as proposed by this invention. It can be seen that the selective compression technique can achieve a higher compression ratio.

Having now fully described the invention, it should be apparent to one of ordinary skill in the art that many modifications can be made hereto without departing from the scope as claimed.

1. A method of deriving a compressed acoustic model for speech recognition, the method comprising
(i) transforming an acoustic model into eigen space to obtain eigenvectors of the acoustic model and their eigenvalues,
(ii) determining predominant characteristics based on the eigenvalues of every dimension of each eigenvector; and
(iii) selectively encoding the dimensions based on the predominant characteristics to obtain the compressed acoustic model.

2. A method according to claim 1, wherein coding the dimensions includes scalar quantizing of the dimensions in eigenspace.

3. A method according to claim 1, wherein determining the predominant characteristics includes identifying eigenvalues that are above a threshold.

4. A method according to claim 3, wherein dimensions corresponding to eigenvalues above the threshold are coded with a higher quantization size than dimensions with eigenvalues below the threshold.

5. A method according to claim 1, further comprising, prior to the selectively encoding, normalising the transformed acoustic model to convert every dimension into a standard distribution.

6. A method according to claim 5, wherein the selectively encoding includes coding each normalised dimension based on a uniform quantization code book.

7. A method according to claim 5, wherein the code book has a one byte size.

8. A method according to claim 6, wherein the normalised dimensions having an importance characteristic higher than an importance threshold is coded using one byte code word.

9. A method according to claim 6, wherein normalised dimensions having an importance characterise lower than an importance threshold is coded using a code word of less than 1 byte.
